(19) United States
(12) Patent Application Publication
(10) Pub. No.: US 2014/0017587 A1
(43) Pub. Date: Jan. 16, 2014

(54) SOLID OXIDE FUEL CELL BONDING MATERIAL, SOLID OXIDE FUEL CELL, AND SOLID OXIDE FUEL CELL MODULE

(71) Applicant: MURATA MANUFACTURING CO., LTD., Nagaokakyo-Shi (JP)

(72) Inventor: Yasuhiko Ueda, Kyoto-Fu (JP)

(73) Assignee: MURATA MANUFACTURING CO., LTD., Nagaokakyo-Shi (JP)

(21) Appl. No.: 14/030,487

(22) Filed: Sep. 18, 2013

Related U.S. Application Data
(63) Continuation of application No. PCT/JP2012/005728, filed on Mar. 22, 2012.

(30) Foreign Application Priority Data
Mar. 31, 2011 (JP) JP2011065708

(51) Int. Cl. H01M 8/02

(52) U.S. Cl. CPC H01M 8/0282
USPC 429/465; 429/510; 429/495

(57) ABSTRACT

A solid oxide fuel cell bonding material contains a glass ceramic layer containing glass ceramic, and a constrained layer laminated on the glass ceramic layer. A solid oxide fuel cell employing the solid oxide fuel cell bonding material is also described.

This is a continuation of Application Ser. No. PCT/JP2012/05728, filed Mar. 22, 2012, the entire contents of which are incorporated herein by reference.

### TECHNICAL FIELD

The present invention relates to a solid oxide fuel cell bonding material, a solid oxide fuel cell, and a solid oxide fuel cell module.

### BACKGROUND ART

In recent years, increasing attention is paid to fuel cells as a new energy source. As the fuel cells, a solid oxide fuel cell (SOFC), a molten carbonate fuel cell, a phosphoric acid fuel cell, a polymer electrolyte fuel cell, and the like can be mentioned. In a solid oxide fuel cell, it is not necessarily a need to use a liquid constituent element, and reforming in the inside is possible when a hydrocarbon fuel is used. For this reason, research and development of a solid oxide fuel cell has been eagerly carried out.

In the solid oxide fuel cell, a bonding material is used, for example, in bonding a power-generating element and a separator with each other. As a specific example of this bonding material, the following Patent Document 1, for example, discloses a bonding material for a solid oxide fuel cell containing glass as a major component.

### PRIOR ART DOCUMENT

### Patent Document

Patent Document 1: Japanese Patent Application Laid-open (JP-A) No. 2011-34874

### SUMMARY OF THE INVENTION

### Problem To Be Solved By The Invention

The bonding material disclosed in Patent Document 1 shrinks in a direction parallel to the bonding interface when heated for bonding a member thereto. For this reason, stress is applied to the bonded member, thereby inviting, for example, warpage to be generated or the bonding material may be damaged.

The present invention has been made in view of the aforementioned circumstances, and an object thereof is to provide a solid oxide fuel cell bonding material that has a high bonding strength and has small shrinkage in the direction parallel to the bonding interface at the time of bonding.

### Means For Solving The Problem

A solid oxide fuel cell bonding material according to the present invention includes a glass ceramic layer and a constrained layer. The glass ceramic layer contains glass ceramics. The constrained layer is laminated on the glass ceramic layer.

In one specific aspect of the solid oxide fuel cell bonding material according to the present invention, the constrained layer is not fired at a temperature of firing the glass ceramic layer. However, part of the glass ceramic layer may be diffused or flow into the constrained layer at the time of firing. In addition, glass having a softening point lower than the firing temperature may be contained in the constrained layer. In this case, the inorganic material of the constrained layer is made dense by the glass components and also functions to enhance the firm bonding to the glass ceramic layer.

In another specific aspect of the solid oxide fuel cell bonding material according to the present invention, the constrained layer contains alumina.

In still another specific aspect of the solid oxide fuel cell bonding material according to the present invention, the constrained layer further contains glass.

In yet another specific aspect of the solid oxide fuel cell bonding material according to the present invention, the content of the alumina in the constrained layer is 30 vol % to 90 vol %. According to this construction, it is possible to suppress the glass component contained in the constrained layer from functioning as an auxiliary agent for firing alumina. Therefore, the effect of suppressing the shrinkage by the constrained layer can be further enhanced.

In still another specific aspect of the solid oxide fuel cell bonding material according to the present invention, the constrained layer is a metal plate. According to this construction, the constrained layer substantially does not shrink in the direction parallel to the bonding interface at the time of firing.

In another specific aspect of the solid oxide fuel cell bonding material according to the present invention, the glass ceramic contains silica, barium oxide, and alumina.

In still another specific aspect of the solid oxide fuel cell bonding material according to the present invention, the glass ceramic contains 48 mass % to 75 mass % of Si in terms of Si0₂, 20 mass % to 40 mass % of Ba in terms of BaO, and 5 mass % to 20 mass % of Al in terms of Al₂O₃.

In yet another specific aspect of the solid oxide fuel cell bonding material according to the present invention, the glass ceramic layer has a thickness of 10 μm to 150 μm. The constrained layer has a thickness of 0.5 μm to 50 μm.

In still another specific aspect of the solid oxide fuel cell bonding material according to the present invention, the glass ceramic layer includes a first glass ceramic layer disposed on a first principal surface of the constrained layer and a second glass ceramic layer disposed on a second principal surface of the constrained layer.

A solid oxide fuel cell according to the present invention includes a bonding layer formed by firing the solid oxide fuel cell bonding material according to the present invention described above.

In one specific aspect of the solid oxide fuel cell according to the present invention, the solid oxide fuel cell further includes a plurality of power-generating cells. Each of the power-generating cells has a solid oxide electrolyte layer, an air electrode disposed on a first principal surface of the solid oxide electrolyte layer, and a fuel electrode disposed on a second principal surface of the solid oxide electrolyte layer. The power-generating cells adjacent to each other are bonded by the bonding layer.

The solid oxide fuel cell module according to the present invention includes a bonding layer formed by firing the solid oxide fuel cell bonding material according to the present invention described above.

In one specific aspect of the solid oxide fuel cell module according to the present invention, the solid oxide fuel cell module includes a fuel cell. The fuel cell has a plurality of power-generating cells, each of which has a solid oxide electrolyte layer, an air electrode disposed on a first principal surface of the solid oxide electrolyte layer, and a fuel electrode disposed on a second principal surface of the solid oxide electrolyte layer. The power-generating cells adjacent to each other are bonded by the bonding layer.

In another specific aspect of the solid oxide fuel cell module according to the present invention, the solid oxide fuel cell module further includes a casing and a fuel cell disposed in the casing. The fuel cell and the casing are bonded by the bonding layer.

### EFFECTS OF THE INVENTION

According to the present invention, there can be provided a solid oxide fuel cell bonding material that has a high bonding strength and has small shrinkage in the direction parallel to the bonding interface at the time of bonding, whereby occurrence of warpage and damage to the bonding material can be suppressed.

### BRIEF EXPLANATION OF DRAWINGS

FIG. 1 is a schematic cross-sectional view of a solid oxide fuel cell bonding material according to a first embodiment.

FIG. 2 is a schematic cross-sectional view of the solid oxide fuel cell bonding material according to a second embodiment.

FIG. 3 is a schematic cross-sectional view of the solid oxide fuel cell bonding material according to a third embodiment.

FIG. 4 is a schematic cross-sectional view of the solid oxide fuel cell bonding material according to a fourth embodiment.

FIG. 5 is a schematic cross-sectional view of the solid oxide fuel cell bonding material according to a fifth embodiment.

FIG. 6 is a model side view of a solid oxide fuel cell module according to a sixth embodiment.

FIG. 7 is a schematic exploded perspective view of a power-generating cell in the sixth embodiment.

FIG. 8 is a schematic cross-sectional view of a first bonding layer in the sixth embodiment.

FIG. 9 is a schematic cross-sectional view of a second bonding layer in the sixth embodiment.

FIG. 10 is a schematic cross-sectional view of a sample prepared in a first example.

FIG. 11 is a schematic cross-sectional view of a sample prepared in a second example.

FIG. 12 is a schematic cross-sectional view of a sample prepared in a fifth example.

FIG. 13 is a schematic cross-sectional view of a sample prepared in a sixth example.

FIG. 14 is a schematic cross-sectional view of a sample prepared in a seventh example.

FIG. 15 is a schematic cross-sectional view of a sample prepared in an eighth example.

FIG. 16 is a schematic cross-sectional view of a sample prepared in a ninth example.

FIG. 17 is a schematic perspective view of a solid oxide fuel cell bonding material in a tenth modification.

FIG. 18 is a schematic perspective view of the solid oxide fuel cell bonding material in an eleventh modification.

FIG. 19 is a schematic perspective view of the solid oxide fuel cell bonding material in a twelfth modification.

### DESCRIPTION OF THE INVENTION

Hereafter, one example of a preferable mode in which the present invention is carried out will be described. However, the following embodiments are merely an exemplification. The present invention is by no means limited to the following embodiments.

In each of the drawings to which reference is made in the embodiments, members substantially having the same function will be denoted with the same reference symbols. In addition, the drawings to which reference is made in the embodiments and the like are model views, so that the ratios and the like of the dimensions of an article depicted in the drawings may in some cases be different from the ratios and the like among the dimensions of an actual article. The ratios and the like among the dimensions of an article may in some cases differ. Specific ratios and the like among the dimensions of an article should be determined by taking the following description into consideration.

### First Embodiment

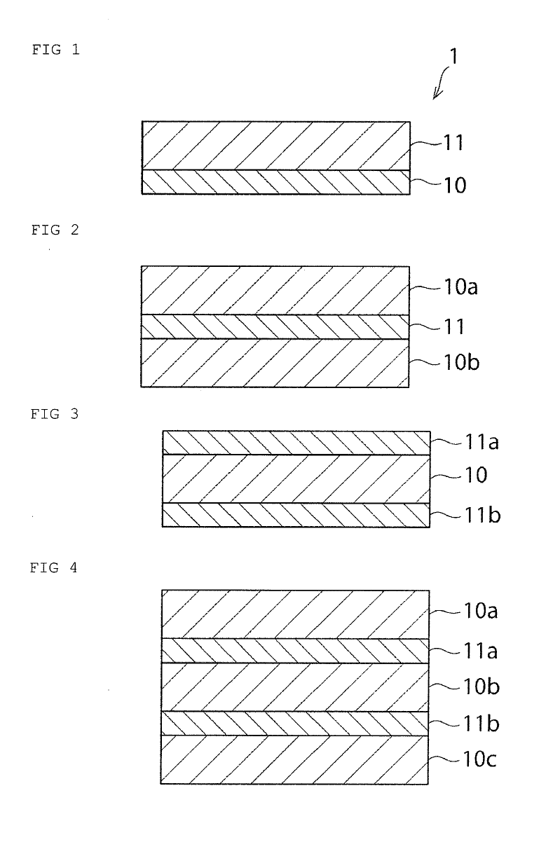

FIG. 1 is a schematic cross-sectional view of a solid oxide fuel cell bonding material according to the first embodiment.

A solid oxide fuel cell bonding material 1 shown in FIG. 1 is a bonding material used in a solid oxide fuel cell. Specifically, the bonding material 1 is used, for example, for bonding the power-generating cells of the solid oxide fuel cell with each other or for bonding a casing of a solid oxide fuel cell module to a fuel cell.

The bonding material 1 has a glass ceramic layer 10 and a constrained layer 11.

The glass ceramic layer 10 contains glass ceramic. The glass ceramic layer 10 may be made of glass ceramic alone or may contain, for example, amorphous glass and the like in addition to the glass ceramic.

The “glass ceramic” meabs a mixed material system of crystallized glass and ceramics. Specific examples of the ceramics include cristobalite, forsterite, cordierite, quartz, quartz glass, alumina, magnesia, and spinel.

In the present embodiment, the glass ceramic contain silica, barium oxide, and alumina. The glass ceramic preferably contain 48 mass % to 75 mass % of Si in terms of SiO₂, 20 mass % to 40 mass % of Ba in terms of BaO, and 5 mass % to 20 mass % of Al in terms of Al₂O₃. The glass ceramic may further contain 2 mass % to 10 mass % of Mn in terms of MnO, 0.1 mass % to 10 mass % of Ti in terms of TiO₂, and 0.1 mass % to 10 mass % of Fe in terms of Fe₂O₃. It is preferable that the glass ceramic substantially do not contain a Cr oxide or a B oxide. According to this construction, glass ceramic that can be fired, for example, at a temperature of 1100° C. or lower can be obtained.

Although the thickness of the glass ceramic layer 10 is not particularly limited, the thickness is preferably, for example, 10 μm to 150 μm, more preferably 20 μm to 50 μm.

The constrained layer 11 is laminated on the glass ceramic layer 10. In the present embodiment, the constrained layer 11 and the glass ceramic layer 10 are in direct contact with each other.

The term “constrained” means that there is substantially no shrinkage in a plane direction. Thus, the constrained layer 11 does not shrink in the plane direction at the temperature of firing the glass ceramic layer 10. In other words, the constrained layer 11 has a property of being capable of allowing the glass ceramic layer 10 to be fired in a state where the constrained layer 11 substantially does not shrink in the plane direction. The constrained layer 11 is preferably made, for example, of a metal plate or ceramics.

The constrained layer 11 preferably contains an inorganic material such as alumina that does not become fired at the temperature of firing the glass ceramics. In this case, the glass ceramic layer 10 can be fired while the constrained layer 11 substantially does not shrink. In addition, the constrained layer 11 preferably contains glass. In this case, the bonding strength between the constrained layer 11 and the layer formed by firing the glass ceramic layer 10 can be increased when the bonding material 1 is fired. The average grain size of the inorganic material is preferably 5 μm or less. When the average grain size of the inorganic material is larger than 5 μm, the effect of suppressing the shrinkage in the plane direction at the time of firing the glass ceramic layer is reduced.

In the constrained layer 11, the volume of glass is preferably 10% to 70% relative to the total volume of alumina and glass. When the volume of glass relative to the total volume of alumina and glass in the constrained layer 11 is lower than 10%, the amount of glass in the constrained layer will be insufficient, and there may be cases where the constrained layer cannot be made dense. On the other hand, when the volume of glass relative to the total volume of alumina and glass in the constrained layer 11 exceeds 70%, the effect of suppressing the shrinkage in the plane direction at the time of firing the glass ceramic layer may in some cases become weak.

The glass contained in the constrained layer 11 may be amorphous glass, or crystalline glass at least part of which is crystallized at the time of firing.

It is also preferable that the constrained layer 11 further contains a glass ceramic. In this case, the bonding strength between the constrained layer and the glass ceramic layer or the bonded article is further increased.

The thickness of the constrained layer 11 is preferably 0.5 μm to 50 μm, more preferably 1 μm to 10 μm. When the thickness of the constrained layer 11 is less than 0.5 μm, the effect of suppressing the shrinkage in the plane direction may in some cases be reduced. On the other hand, when the thickness of the constrained layer 11 exceeds 50 μm, it may in some cases become difficult to reduce the height of the solid oxide fuel cell. In addition, the thickness of the constrained layer 11 is preferably 0.05 to 0.25 times the thickness of the glass ceramic layer 10.

It is also conceivable to construct the bonding material only with a glass ceramic layer. Even in this case, an excellent bonding property can be realized.

However, a bonding material made only of a glass ceramic layer shrinks also in the plane direction at the time of firing. For this reason, large stress is generated in the bonded material or the bonding layer formed by firing the glass ceramic layer. Therefore, there are cases where the bonded material may be warped, or cracks and the like may be generated in the bonded material or the bonding layer. In addition, the bonding material is liable to be exfoliated from the bonded material. In other words, it is difficult to obtain a sufficient bonding strength.

In contrast, the glass ceramic layer 10 and the constrained layer 11 in the present embodiment are laminated on each other. By this constrained layer 11, the glass ceramic layer 10 is suppressed from shrinking in the plane direction at the time of firing, and shrinks mainly in the thickness direction. When the bonding material 1 of the present embodiment is used, the bonding material 1 does not shrink too much in the plane direction even at the time of firing the bonding material 1. Therefore, the stress is suppressed from being applied to the bonded material or the bonding layer. As a result of this, warpage of the bonded material and generation of cracks in the bonded material and the bonding layer can be suppressed. In addition, the bonded materials can be bonded with each other at a high bonding strength. In other words, the bonding material 1 of the present embodiment has an excellent bonding property and has small shrinkage at the time of firing.

When the bonding material is constituted only of a constrained layer, the bonding property will be low, and a function as the bonding material cannot be sufficiently obtained.

From the viewpoint of more effectively suppressing the shrinkage of the bonding material 1 in the plane direction at the time of firing the bonding material 1, it is preferable that the constrained layer 11 substantially does not become fired at the temperature of firing the glass ceramic layer 10. From this viewpoint, the constrained layer 11 preferably contains alumina, and more preferably contains 30 vol % or more of alumina. However, when the content ratio of alumina in the constrained layer 11 is too high, the inside of the constrained layer is not made dense by the glass ceramic, so that the strength of the bonding material may in some cases decrease. For this reason, the content ratio of alumina in the constrained layer 11 is preferably 90 vol % or less.

Hereafter, other examples of preferable modes in which the present invention is carried out will be described. In the following description, members having a function substantially common to that of the first embodiment will be denoted with common reference symbols, and the description thereof will be omitted.

### Second to Fifth Embodiments

FIG. 2 is a schematic cross-sectional view of the solid oxide fuel cell bonding material according to the second embodiment. FIG. 3 is a schematic cross-sectional view of the solid oxide fuel cell bonding material according to the third embodiment. FIG. 4 is a schematic cross-sectional view of the solid oxide fuel cell bonding material according to the fourth embodiment. FIG. 5 is a schematic cross-sectional view of the solid oxide fuel cell bonding material according to the fifth embodiment.

In the first embodiment, an example has been described in which the bonding material 1 is constituted of a laminate of one glass ceramic layer 10 and one constrained layer 11. However, the present invention is not limited to this construction alone.

For example, referring to FIGS. 2 to 5, at least one of the glass ceramic layer 10 and the constrained layer 11 may be provided in plurality.

In the example shown in FIG. 2, a first glass ceramic layer 10a is disposed on a first principal surface of the constrained layer 11, and a second glass ceramic layer 10b is disposed on a second principal surface of the constrained layer 11. Thus, both surfaces of the bonding material are constituted of a glass ceramic layer. Therefore, both of the bonding strength between the bonding material and the bonded material that is bonded to the first principal surface of the bonding material and the bonding strength between the bonding material and the bonded material that is bonded to the second principal surface of the bonding material can be further enhanced.

In the example shown in FIG. 3, constrained layers 11a and 11b are disposed on the two surfaces of the glass ceramic layer 10. In other words, the glass ceramic layer 10 is interposed between the constrained layers 11a and 11b. Therefore, shrinkage in the plane direction at the time of firing the glass ceramic layer 10 can be more effectively suppressed.

In the example shown in FIG. 4, two constrained layers 11a and 11b are disposed between three glass ceramic layers 10a to 10c. For this reason, both surfaces of the bonding material are constituted of a glass ceramic layer. Therefore, both of the bonding strength between the bonding material and the bonded material that is bonded to the first principal surface of the bonding material and the bonding strength between the bonding material and the bonded material that is bonded to the second principal surface of the bonding material can be further enhanced. In addition, because the number of constrained layers relative to the number of glass ceramic layers is larger than that in the bonding material shown in FIG. 2, shrinkage in the plane direction at the time of firing the glass ceramic layers 10a to 10c can be more effectively suppressed.

In the example shown in FIG. 5, two glass ceramic layers 10a and 10b and two constrained layers 11a and 11b are alternately laminated. Even with this bonding material, an effect similar to that of the bonding material 1 according to the first embodiment is produced. In addition, the thickness of the bonding material can be adjusted.

### Sixth Embodiment

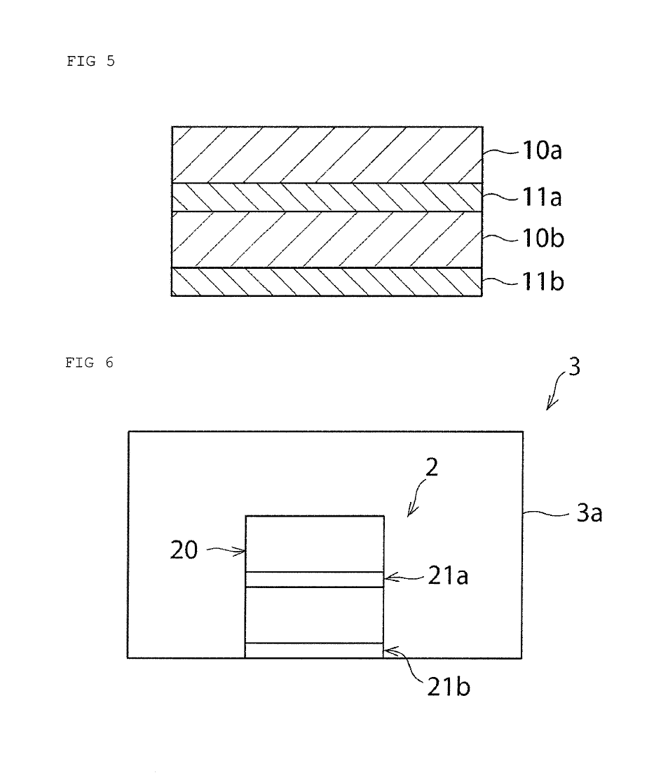

FIG. 6 is a model side view of a solid oxide fuel cell module according to the sixth embodiment.

Referring to FIG. 6, a solid oxide fuel cell module (also referred to as a hot module) 3 includes a casing 3a. A solid oxide fuel cell 2 is disposed in the inside of the casing 3a.

The fuel cell 2 has a plurality of power-generating cells 20. Specifically, the fuel cell 2 has two power-generating cells 20 in this figure.

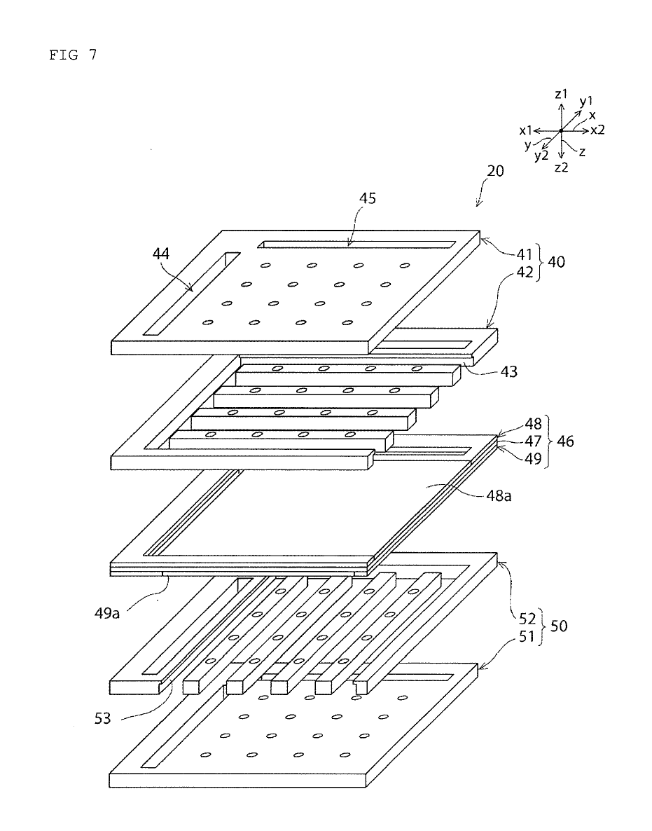

FIG. 7 is a schematic exploded perspective view of a power-generating cell in the sixth embodiment. Referring to FIG. 7, the power-generating cell 20 has a first separator 40, a power-generating element 46, and a second separator 50. In the power-generating cell 20, the first separator 40, the power-generating element 46, and the second separator 50 are laminated in this order.

### Power-Generating Element 46

The power-generating element 46 is a part where an oxidant gas supplied from a manifold 44 for an oxidant gas and a fuel gas supplied from a manifold 45 for a fuel gas react with each other to generate electric power. The oxidant gas can be constituted, for example, of an aerobic gas containing air or oxygen. In addition, the fuel gas can be a gas containing a hydrogen gas, a city gas, a hydrocarbon gas such as a liquefied petroleum gas or gasified lamp oil, or the like.

### Solid Oxide Electrolyte Layer 47

The power-generating element 46 includes a solid oxide electrolyte layer 47. The solid oxide electrolyte layer 47 preferably has high ion conductivity. The solid oxide electrolyte layer 47 can be formed, for example, of stabilized zirconia, partially stabilized zirconia, or the like. Specific examples of stabilized zirconia include 10 mol % yttria-stabilized zirconia (10YSZ) and 11 mol % scandia-stabilized zirconia (11ScSZ). A specific examples of partially stabilized zirconia is 3 mol % yttria-partially-stabilized zirconia (3YSZ). Alternatively, the solid oxide electrolyte layer 47 can be formed, for example, of a ceria-based oxide doped with Sm, Gd, or the like, a perovskite-type oxide such as La_{0.8}Sr_{0.2}Ga_{0.8}Mg_{0.2}O_{(3-δ)} obtained by using LaGaO₃ as a matrix in which part of La and Ga is replaced with Sr and Mg, respectively, or the like.

The solid oxide electrolyte layer 47 is interposed between an air electrode layer 48 and a fuel electrode layer 49. In other words, the air electrode layer 48 is formed on a first principal surface of the solid oxide electrolyte layer 47, and the fuel electrode layer 49 is formed on a second principal surface of the solid oxide electrolyte layer 47.

### Air Electrode Layer 48

The air electrode layer 48 has an air electrode 48a. The air electrode 48a is a cathode. In the air electrode 48a, oxygen captures electrons to form oxygen ions. It is preferable that the air electrode 48a is porous, has high electron conductivity, and is less liable to cause solid-to-solid reaction with the solid oxide electrolyte layer 47 at a high temperature. The air electrode 48a can be formed, for example, of scandia-stabilized zirconia (ScSZ), indium oxide doped with Sn, a PrCoO₃-based oxide, a LaCoO₃-based oxide, a LaMnO₃-based oxide, or the like. Specific examples of the LaMnO₃-based oxide include La_{0.8}Sr_{0.2}MnO₃ (popular name: LSM), La_{0.8}Sr_{0.2}Co_{0.2}Fe_{0.8}O₃(popular name: LSCF), and La_{0.6}Ca_{0.4}MnO₃(popular name: LCM). The air electrode 48a may be constituted of a mixed material obtained by mixing two or more kinds of the above materials.

### Fuel Electrode Layer 49

The fuel electrode layer 49 has a fuel electrode 49a. The fuel electrode 49a is an anode. In the fuel electrode 49a, oxygen ions and a fuel gas react with each other to release electrons. It is preferable that the fuel electrode 49a is porous, has high electron conductivity, and is less liable to cause solid-to-solid reaction with the solid oxide electrolyte layer 47 at a high temperature. The fuel electrode 49a can be formed, for example, of NiO, porous cermet of yttria-stabilized zirconia (YSZ) and nickel metal, porous cermet of scandia-stabilized zirconia (ScSZ) and nickel metal, or the like. The fuel electrode layer 49 may be constituted of a mixed material obtained by mixing two or more kinds of the above materials.

### First Separator 40

The first separator 40 constituted of a first separator body 41 and a first flow path forming member 42 is disposed on the air electrode layer 48 of the power-generating element 46. An oxidant gas flow path 43 for supplying an oxidant gas to the air electrode 48a is formed in the first separator 40. This oxidant gas flow path 43 extends from the x1 side of the x-direction towards the x2 side from the manifold 44 for an oxidant gas.

The material constituting the first separator 40 is not particularly limited. The first separator 40 can be formed, for example, of stabilized zirconia such as yttria-stabilized zirconia, partially stabilized zirconia, or the like.

### Second Separator 50

The second separator 50 constituted of a second separator body 51 and a second flow path forming member 52 is disposed on the fuel electrode layer 49 of the power-generating element 46. A fuel gas flow path 53 for supplying a fuel gas to the fuel electrode 49a is formed in the second separator 50. This fuel gas flow path 53 extends from the y1 side of the y-direction towards the y2 side from the manifold 45 for a fuel gas.

The material constituting the second separator 50 is not particularly limited. The second separator 50 can be formed, for example, of stabilized zirconia, partially stabilized zirconia, or the like.

In the present embodiment, the two power-generating cells 20 are bonded with each other by using the bonding material 1 described in the first embodiment. Specifically, the two are bonded by a first bonding layer 21a formed by firing the bonding material 1.

FIG. 8 is a schematic cross-sectional view of the first bonding layer in the sixth embodiment. Referring to FIG. 8, the first bonding layer 21a is constituted of a laminate of a fired layer 22 formed by firing the glass ceramic layer 10 and the constrained layer 11.

Referring to FIG. 6, the fuel cell 2 is bonded to the casing 3a. In order to transmit the heat uniformly, the fuel cell 2 may be placed in the casing 3a after being bonded to a soaking plate. The fuel cell 2 and the casing 3a are bonded with each other by a second bonding layer 21b.

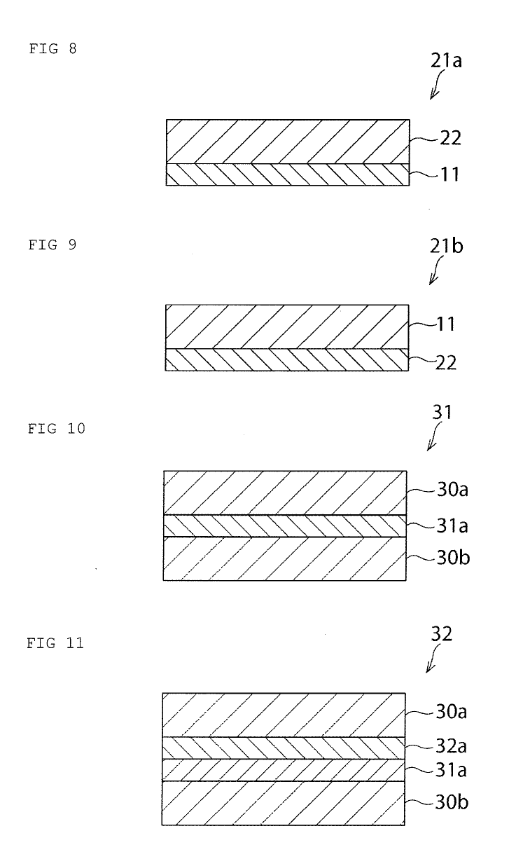

FIG. 9 is a schematic cross-sectional view of the second bonding layer in the sixth embodiment. Here, the second bonding layer 21b also is constituted of a laminate of a fired layer 22 formed by firing the glass ceramic layer 10 and the constrained layer 11 in the same manner as the first bonding layer 21a.

As described above, adjacent power-generating cells 20 in the present embodiment are bonded with each other by the first bonding layer 21a formed by firing the bonding material 1. In addition, the fuel cell 2 and the casing 3a are bonded with each other by the second bonding layer 21b formed by firing the bonding material 1. For this reason, warpage of the power-generating cells 20 and generation of cracks in the power-generating cells 20 can be suppressed.

In the present embodiment, an example has been described in which the bonding layers 21a and 21b are formed by firing the bonding material 1. However, the present invention is not limited to this construction. The bonding layers may be formed, for example, by firing one of the bonding materials according to the second to fifth embodiments.

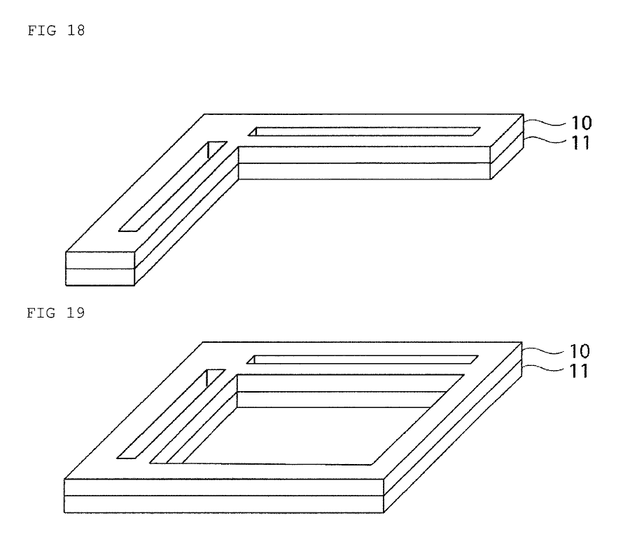

Referring to FIG. 17, the solid oxide fuel cell bonding material may be provided in a Ushape when viewed in a plan view. Referring to FIG. 18, the solid oxide fuel cell bonding material may be provided in an L-shape when viewed in a plan view. Referring to FIG. 19, the solid oxide fuel cell bonding material may be provided in a ring shape.

### EXAMPLE 1

In Example 1, a sample 31 shown in FIG. 10 was prepared. First, a slurry was prepared by adding polyvinyl butyral as a binder, di-n-butyl phthalate as a plasticizer, and toluene and isopropylene alcohol as solvents to a glass ceramic having a composition A shown in the following Table 1. By using the slurry, ceramic green sheets of a glass ceramic layer were prepared by the doctor blade method. A laminate obtained by laminating the ceramic green sheets of the glass ceramic layer was pressed at a pressure of 500 kgf/cm² at a temperature of 50° C., so as to obtain a glass ceramic layer 31a. The glass ceramic layer 31a was interposed between substrates 30a and 30b containing zirconia as a major component, so as to obtain the sample 31. In other words, in the sample 31, the bonding material is constituted of the glass ceramic layer 31a alone.

### EXAMPLE 2

As an inorganic material powder that is not fired at the temperature of firing glass ceramics, an alumina powder having an average particle size of 0.5 μm was used, and as a glass powder, borosilicate glass having an average particle size of 1.3 μm was used. After mixing the alumina powder with the glass powder at a volume ratio of 6:4, a slurry was prepared by adding polyvinyl butyral as a binder, di-n-butyl phthalate as a plasticizer, and toluene and isopropylene alcohol as solvents. By using the slurry, a ceramic green sheet of a constrained layer was prepared by the doctor blade method. A laminate obtained by laminating this ceramic green sheet of the constrained layer and the ceramic green sheets of the ceramic glass layer prepared in the same manner as in Example 1 was pressed at a pressure of 500 kgf/cm² at a temperature of 50° C., so as to obtain a laminate of the glass ceramic layer 31a and the constrained layer 32a. The above-described borosilicate glass has a composition in which 55 mol % of SiO₂, 4 mol % of Al₂O₃, 10 mol % of B₂O₃, 20 mol % of BaO, 5.5 mol % of CaO, 0.5 mol % of MgO, and 5 mol % of SrO are contained.

Next, referring to FIG. 11, the laminate of the glass ceramic layer 31a and the constrained layer 32a was interposed between substrates 30a and 30b containing zirconia as a major component in the same manner as in Example 1 described above, so as to obtain a sample 32.

In the present example, the bonding material was prepared by separately preparing and laminating the glass ceramic layer and the constrained layer; however, the constrained layer may be subjected to sheet-molding on the glass ceramic layer.

In addition, the lamination structure of the glass ceramic layer and the constrained layer is not limited to lamination of sheets, and similar effects are produced also by a paste construction method, printing construction method, aerosol deposition, or the like.

### EXAMPLE 3

A sample was prepared in the same manner as in Example 2 except that the thickness of the glass ceramic layer 31a and the thickness of the constrained layer 32a were set to be the thicknesses shown in the following Table 2.

### EXAMPLE 4

A sample was prepared in the same manner as in Example 2 except that the thickness of the glass ceramic layer 31a and the thickness of the constrained layer 32a were set to be the thicknesses shown in Table 2.

### EXAMPLE 5

Referring to FIG. 12, a sample 33 was prepared by interposing a laminate, in which the constrained layer 32a, the glass ceramic layer 31a, and the constrained layer 32a were laminated in this order, between substrates 30a and 30b containing zirconia as a major component.

### EXAMPLE 6

Referring to FIG. 13, a sample 34 was prepared by interposing a laminate, in which the glass ceramic layer 31a, the constrained layer 32a, and the glass ceramic layer 31a were laminated in this order, between substrates 30a and 30b containing zirconia as a major component.

### EXAMPLE 7

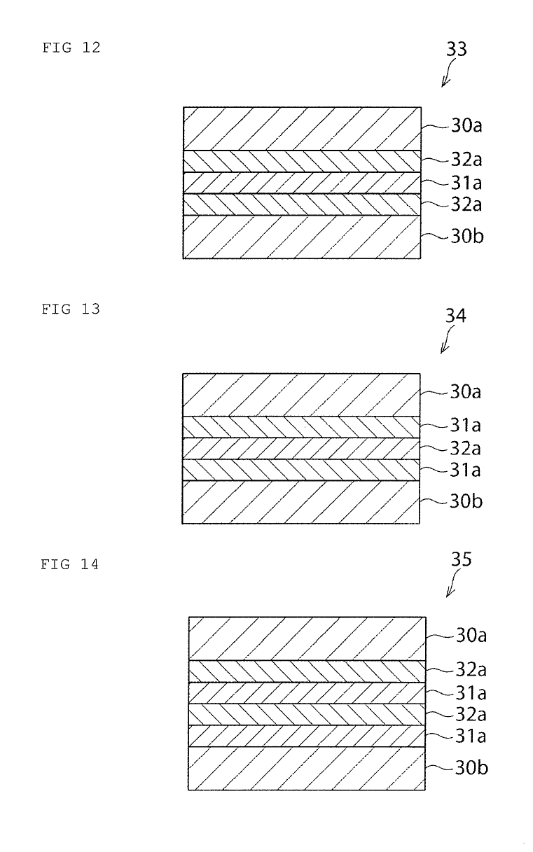

Referring to FIG. 14, a sample 35 was prepared by interposing a laminate, in which the constrained layer 32a, the glass ceramic layer 31a, the constrained layer 32a, and the glass ceramic layer 31a were laminated in this order, between substrates 30a and 30b containing zirconia as a major component.

### EXAMPLE 8

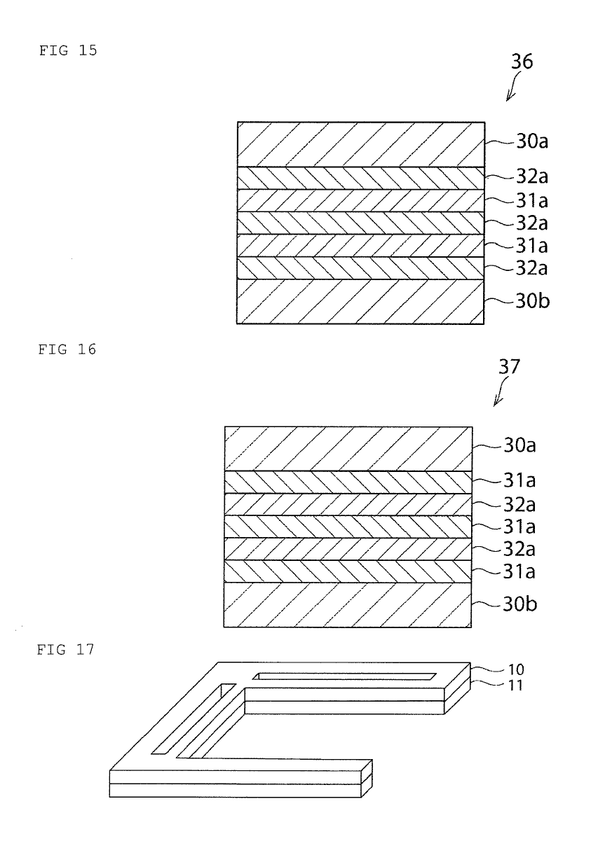

Referring to FIG. 15, a sample 36 was prepared by interposing a laminate, in which the constrained layer 32a, the glass ceramic layer 31a, the constrained layer 32a, the glass ceramic layer 31a, and the constrained layer 32a were laminated in this order, between substrates 30a and 30b containing zirconia as a major component.

### EXAMPLE 9

Referring to FIG. 16, a sample 37 was prepared by interposing a laminate, in which the glass ceramic layer 31a, the constrained layer 32a, the glass ceramic layer 31a, the constrained layer 32a, and the glass ceramic layer 31a were laminated in this order, between substrates 30a and 30b containing zirconia as a major component.

### EXAMPLE 10

A sample was prepared in the same manner as in Example 2 except that the glass ceramic was set to have a composition B shown in the following Table 1.

### EXAMPLE 11

A sample was prepared in the same manner as in Example 2 except that the glass ceramic was set to have a composition C shown in the following Table 1.

### EXAMPLE 12

A sample was prepared in the same manner as in Example 2 except that the glass ceramic was set to have a composition D shown in the following Table 1.

### EXAMPLE 13

A sample was prepared in the same manner as in Example 2 except that the glass ceramic was set to have a composition E shown in the following Table 1.

### EXAMPLE 14

A sample was prepared in the same manner as in Example 2 except that the glass ceramic was set to have a composition F shown in the following Table 1.

### EXAMPLE 15

A sample was prepared in the same manner as in Example 2 except that the glass ceramic was set to have a composition G shown in the following Table 1.

### EXAMPLE 16

A sample was prepared in the same manner as in Example 2 except that the glass ceramic was set to have a composition H shown in the following Table 1.

### EXAMPLE 17

A sample was prepared in the same manner as in Example 2 except that the glass ceramic had a composition I shown in the following Table 1.

### EXAMPLE 18

A sample was prepared in the same manner as in Example 2 except that the glass ceramic had a composition J shown in the following Table 1.

### EVALUATION

The samples prepared in each of Examples 1 to 18 were fired at 1000° C. for one hour. Thereafter, the part where the bonding material is bonded to the substrate was observed with a microscope. As a result of this, numerous cracks were confirmed in Example 1. No cracks were observed in Examples 2 to 18.

### EXAMPLE 19

Under the conditions shown below, a power-generating cell substantially having the same construction as that of the power-generating cell according to the above sixth embodiment was prepared by integrally firing the constituent members shown below.

Constituent material of separator: 3YSZ (ZrO₂ stabilized with Y₂O₃added in an amount of 3 mol %)

Constituent material of solid oxide electrolyte layer: ScSZ (ZrO₂ stabilized with Sc₂O₃ added in an amount of 10 mol % and CeO₂ added in an amount of 1 mol %)

Constituent material of air electrode: one in which 30 mass % of a carbon powder is added to a mixture of 60 mass % of a La_{0.8}Sr_{0.2}MnO₃ powder and 40 mass % of ScSZ

Constituent material of fuel electrode: one in which 30 mass % of a carbon powder is added to a mixture of 65 mass % of NiO and 35 mass % of ScSZ

Constituent material of the part of an interconnector on the fuel electrode side that is located closer to the fuel electrode side than an intermediate film: a mixture of 70 mass % of NiO and 30 mass % of TiO₂

Constituent material of the part of the interconnector that is located closer to the side opposite to the fuel electrode than the intermediate film: a Pd—Ag alloy in which the content of Pd is 30 mass %

Diameter of via hole: 0.2 mm

Thickness of intermediate film: 30 μm

Thickness of fuel electrode: 30 μm

Thickness of air electrode: 30 μm

Thickness of solid oxide electrolyte layer: 30 μm

Height of streak protrusion: 240 μm

Thickness of separator body: 360 μm

Conditions for pressing before firing: 1000 kgf/cm²

Firing temperature: 1150° C.

Two power-generating cells prepared under the above-described conditions were provided, and the bonding material prepared in Example 1 and an electroconductive paste were interposed between the two power-generating cells. Then, while applying a load of 1 kg, the resultant was fired at 1000° C. for one hour to prepare a fuel cell. An N₂ gas was allowed to flow through each of the manifold for a fuel gas and the manifold for an oxidant gas of the fuel cell at room temperature. The presence or absence of gas leakage when the pressure within the manifolds was 10 kPa was confirmed by using a leakage checker made of a commercially available surfactant, so as to evaluate the sealing property of the solid oxide fuel cell bonding material. As a result of this, no gas leakage was seen.

TABLE 1

| | Composition (mass %) | | |
|---|---|---|---|
| Composition | SiO₂ | BaO | Al₂O₃ |
| A | 57.0 | 31.0 | 12.0 |
| B | 48.0 | 40.0 | 12.0 |
| C | 52.0 | 35.0 | 13.0 |
| D | 60.0 | 31.0 | 9.0 |
| E | 75.0 | 20.0 | 5.0 |
| F | 52.0 | 31.0 | 17.0 |
| G | 48.0 | 32.0 | 20.0 |
| H | 57.0 | 31.0 | 12.0 |
| I | 57.0 | 25.0 | 18.0 |
| J | 63.0 | 22.0 | 15.0 |

TABLE 2

| Example | 1 | 2 | 3 | 4 | 5 | 6 | 7 | 8 | 9 |
|---|---|---|---|---|---|---|---|---|---|
| Composition | A | A | A | A | A | A | A | A | A |
| of glass | | | | | | | | | |
| ceramic | | | | | | | | | |
| powder | | | | | | | | | |
| Thickness | 50 | 50 | 10 | 150 | 50 | 50 | 50 | 50 | 50 |
| (μm) of | | | | | | | | | |
| glass | | | | | | | | | |
| ceramic film | | | | | | | | | |
| Thickness | None | 5 | 1 | 30 | 5 | 5 | 5 | 5 | 5 |
| (μm) of | | | | | | | | | |
| constrained | | | | | | | | | |
| film | | | | | | | | | |
| Generation | Present | Absent | Absent | Absent | Absent | Absent | Absent | Absent | Absent |
| of cracks | | | | | | | | | |
| Example | 10 | 11 | 12 | 13 | 14 | 15 | 16 | 17 | 18 |
| Composition | B | C | D | E | F | G | H | I | J |
| of glass | | | | | | | | | |
| ceramic | | | | | | | | | |
| powder | | | | | | | | | |
| Thickness | 50 | 50 | 50 | 50 | 50 | 50 | 50 | 50 | 50 |
| (μm) of | | | | | | | | | |
| glass | | | | | | | | | |
| ceramic film | | | | | | | | | |
| Thickness | 5 | 5 | 5 | 5 | 5 | 5 | 5 | 5 | 5 |
| (μm) of | | | | | | | | | |
| constrained | | | | | | | | | |
| film | | | | | | | | | |
| Generation | Absent | Absent | Absent | Absent | Absent | Absent | Absent | Absent | Absent |
| of cracks | | | | | | | | | |

### DESCRIPTION OF REFERENCE SYMBOLS

1 . . . solid oxide fuel cell bonding material

2 . . . solid oxide fuel cell

3a . . . casing

10, 10a to 10c . . . glass ceramic layer

11, 11a, 11b . . . constrained layer

20 . . . power-generating cell

21a . . . first bonding layer

21b . . . second bonding layer

22 . . . fired layer

40 . . . first separator

41 . . . first separator body

42 . . . first flow path forming member

43 . . . oxidant gas flow path

44 . . . manifold for oxidant gas

45 . . . manifold for fuel gas

46 . . . power-generating element

47 . . . solid oxide electrolyte layer

48 . . . air electrode layer

48a . . . air electrode

49 . . . fuel electrode layer

49a . . . fuel electrode

50 . . . second separator

51 . . . second separator body

52 . . . second flow path forming member

53 . . . fuel gas flow path

1. A solid oxide fuel cell bonding material comprising:
a layer of glass ceramic, and laminated thereto, a constrained layer comprising material which does not shrink substantially in a plane direction at the firing temperature of the glass ceramic layer.

2. The solid oxide fuel cell bonding material according to claim 1, wherein the constrained layer has a firing temperature higher than the firing temperature of the glass ceramic layer.

3. The solid oxide fuel cell bonding material according to claim 2, wherein the constrained layer comprises alumina.

4. The solid oxide fuel cell bonding material according to claim 3, wherein the constrained layer further comprises glass.

5. The solid oxide fuel cell bonding material according to claim 3, wherein the content of the alumina in the constrained layer is 30 vol % to 90 vol %.

6. The solid oxide fuel cell bonding material according to claim 1, wherein the constrained layer is a metal plate.

7. The solid oxide fuel cell bonding material according to claim 1, wherein the glass ceramic comprises silica, barium oxide, and alumina.

8. The solid oxide fuel cell bonding material according to claim 7, wherein the glass ceramic comprises 48 mass % to 75 mass % of Si in terms of SiO₂, 20 mass % to 40 mass % of Ba in terms of BaO, and 5 mass % to 20 mass % of Al in terms of Al₂O₃.

9. The solid oxide fuel cell bonding material according to claim 8, wherein the glass ceramic layer has a thickness of 10 μm to 150 μm, and the constrained layer has a thickness of 0.5 μm to 50 μm.

10. The solid oxide fuel cell bonding material according to claim 9, wherein the constrained layer comprises an inorganic material having an average particle size of less than 5 μm, has a thickness of 1 μm to 10 μm, and has a thickness which is 0.02 to 0.25 the thickness of the glass ceramic layer.

11. The solid oxide fuel cell bonding material according to claim 9, wherein the glass ceramic layer is disposed on a first principal surface of the constrained layer and a second glass ceramic layer disposed on a second principal surface of the constrained layer.

12. The solid oxide fuel cell bonding material according to claim 1, wherein the glass ceramic layer is disposed on a first principal surface of the constrained layer and a second glass ceramic layer disposed on a second principal surface of the constrained layer.

13. A solid oxide fuel cell comprising a bonding layer which comprises a fired solid oxide fuel cell bonding material according to claim 12

14. The solid oxide fuel cell module according to claim 13, in which a fuel cell is disposed in a casing, and the fuel cell and the casing are bonded by a bonding layer.

15. A solid oxide fuel cell comprising a bonding layer which comprises a fired solid oxide fuel cell bonding material according to claim 9.

16. The solid oxide fuel cell according to claim 15, further comprising a plurality of power-generating cells, each of which has a solid oxide electrolyte layer, an air electrode disposed on a first principal surface of the solid oxide electrolyte layer, and a fuel electrode disposed on a second principal surface of the solid oxide electrolyte layer, wherein power-generating cells adjacent to each other are bonded by the bonding layer.

17. The solid oxide fuel cell module according to claim 16, in which a fuel cell is disposed in a casing, and the fuel cell and the casing are bonded by a bonding layer.

18. A solid oxide fuel cell comprising a bonding layer which comprises a fired solid oxide fuel cell bonding material according to claim 1.

19. The solid oxide fuel cell according to claim 18, further comprising a plurality of power-generating cells, each of which has a solid oxide electrolyte layer, an air electrode disposed on a first principal surface of the solid oxide electrolyte layer, and a fuel electrode disposed on a second principal surface of the solid oxide electrolyte layer, wherein power-generating cells adjacent to each other are bonded by the bonding layer.

20. The solid oxide fuel cell module according to claim 18, in which a fuel cell is disposed in a casing, and the fuel cell and the casing are bonded by a bonding layer.
